(19) United States
(12) Patent Application Publication
(10) Pub. No.: US 2011/0153527 A1
(43) Pub. Date: Jun. 23, 2011

(54) REUSABLE ENVELOPE WITH A PAIR OF ADHESIVE STRIPS

(76) Inventor: Stephen Francis Smythe, Warkworth (NZ)

(21) Appl. No.: 12/996,169

(22) PCT Filed: Jun. 3, 2009
(86) PCT No.: PCT/NZ09/00093

§ 371 Date: Mar. 7, 2011

(30) Foreign Application Priority Data
Jun. 4, 2008 (NZ) 568817

(51) Int. Cl. B65D 27/06; B65D 27/38; B65D 27/04; B65D 27/12; G06Q 90/00

(52) U.S. Cl. 705/500; 229/305; 229/310; 229/71; 229/76

(57) ABSTRACT

The invention comprises a blank for an envelope including a front panel, a rear panel and a closure panel, the closure panel being connectable in use to the front panel, the blank having two gluing areas by which the closure panel may be connected to the front panel in use. A removable strip is provided between the gluing areas, the removable strip being of sufficient dimensions to receive indicia associated with a first mailing thereon, at least some of which indicia are removed when the envelope is opened by removing the removable strip after the first mailing. The envelope may also have a second removable area. The removable strip may be wide enough to reveal a response indicia imprinted on the first panel.

### TECHNICAL FIELD

This invention relates to a blank for an envelope, and in particular a blank for an envelope able to be used a second time.

### BACKGROUND ART

There is a strong movement today towards waste reduction and maximizing the life of, or minimizing the utilization of, resources. Paper use is one such resource. Envelopes that can be reused either to provide a return or two trip envelope or which can be re-used are desirable.

### OBJECT OF THE INVENTION

It is an object of the invention to provide an envelope that will go at least some way towards meeting the foregoing requirements or which will at least provide the public with a useful choice.

### SUMMARY OF INVENTION

In a first aspect the invention consists in a blank for an envelope including a front panel, a rear panel and a closure panel, the closure panel being connectable in use to the front panel, the blank having two sealing areas by which the closure panel may be connected to the front panel in use, a removable strip between the sealing areas, the removable strip being of sufficient dimensions to receive indicia associated with a first mailing thereon, at least some of which indicia are removed when the envelope is opened by removing the removable strip after the first mailing.

Thus this invention applies to a re-usable envelope mailpiece where once the envelope is opened by the first recipient unzipping the removable strip on the flap or closure panel, certain markings on the closure panel are removed. These markings may include a business house logo or brand including an “if undelivered please return to (address) message, a Route Code placed by the postal service, or the method of postage payment, which may be a stamp or printed postage impression or indicia, any or all of which are placed on the removable strip for the first mailing.

Optionally a second mailing prepaid indicia is provided on the front panel which becomes at least substantially visible in use when the removable strip is removed.

Optionally a stamp can be placed on the front panel which becomes at least substantially visible in use when the removable strip is removed.

Optionally a second mailing part payment indicia is provided on the front panel which becomes at least substantially visible in use when the removable strip is removed.

Optionally a permit indicia may be provided on the front panel which becomes at least substantially visible in use when the removable strip is removed.

Preferably, the removable strip is at least substantially 10 mm in width.

Preferably the removable strip is between substantially 16 mm and substantially 17 mm in width.

Preferably a second prepaid indicia is provided on the front panel and the second prepaid indicia may be associated with a selected indicia, permit or license.

Preferably the selected indicia is a number.

Preferably a response sheet is provided with the first mailing, the response sheet carrying an indicia associable with the selected indicia associated with the second prepaid indicia.

Preferably the indicia on the response sheet is a number and/or a barcode.

Preferably the blank includes a window, and the response sheet is dimensioned so that in use during the second mailing the selected indicia on the response sheet is visible through the window.

Preferably the selected indicia and the indicia on the response sheet are substantially the same or are associated one with the other.

In a further aspect the invention consists in an envelope formed from a blank according to any one of the preceding paragraphs.

In a still further aspect the invention consists in a method of billing a postal transaction including the steps of providing an envelope according to the preceding paragraph, which envelope has a window, a response sheet carrying an indicia, a prepaid indicia, and a selected indicia associated with the prepaid indicia, passing the envelope through a mail scanning device during the second mailing of the envelope, checking that the indicia on the response sheet is correctly associated with the selected indicia and/or the prepaid indicia.

Preferably said method further includes the step of billing the entity providing the response sheet or some other entity if the response indicia on the response envelope is correctly associated with the indicia on the response sheet.

Preferably the correct association occurs when the numbers are substantially the same or the response indicia on the envelope matches a barcode which is associated with the selected indicia.

In a still further aspect the invention consists in a blank for an envelope including a front panel, a rear panel and a closure panel, the closure panel being connectable in use to the front panel, the blank having two sealing areas by which the closure panel may be connected to the front panel in use, a removable strip between the sealing areas, and a further removable strip or panel in or on the blank and independent of the removable strip.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

The invention will now be described, by way of example only, by reference to the accompanying drawings:

FIG. 1 is a front plan view of an envelope formed from a blank according to a first preferred embodiment of the invention and as used during a first use of the envelope and FIG. 1A shows an alternative perforation pattern,

FIG. 2 is a view as in FIG. 1 with a tear strip removed and as used prior to a second use of the envelope where payment is by stamp,

FIG. 3 is a view as in FIGS. 1 and 2 of the envelope during a second use where payment is by permit or license and FIG. 3A shows an alternative response indicia,

FIG. 4 is plan view of one end of a blank according to a preferred from of the invention. Although FIG. 4 shows angles and dimensions those angles and dimensions are by way of example only unless specified as essential in the following description of the invention. The blank includes a closure flap which is shown in two positions,

FIG. 5 is a view as in FIG. 2 of a further alternative envelope according to a preferred form of the invention,

FIG. 6 is side view of a further envelope according to a preferred form of the invention closed for a first use of the envelope,

FIG. 7 is a view of the envelope of FIG. 6 closed for a second use of the envelope,

FIG. 8 is view showing the closure flap of the envelope of FIG. 6 in an open position,

FIG. 9 is a view as for FIG. 8 but with the closure flap closed for a first use of the envelope,

FIG. 10 is a view as in FIG. 8 with the closure in use for a second use of the envelope,

FIGS. 11 to 13 are respectively front and rear views of the first use, and a front view of the second use of a further alternative envelope according to a preferred form of the invention, and

FIG. 14 is a plan view of a blank for use in forming an envelope in a still further alternative embodiment of the invention.

### DESCRIPTION OF DRAWINGS

The following description will describe the invention in relation to preferred embodiments of the invention, namely a blank for an envelope and/or an envelope and/or a method of billing a postal transaction. The invention is in no way limited to these preferred embodiments as they are purely to exemplify the invention. Possible variations and modifications will be readily apparent without departing from the scope of the invention.

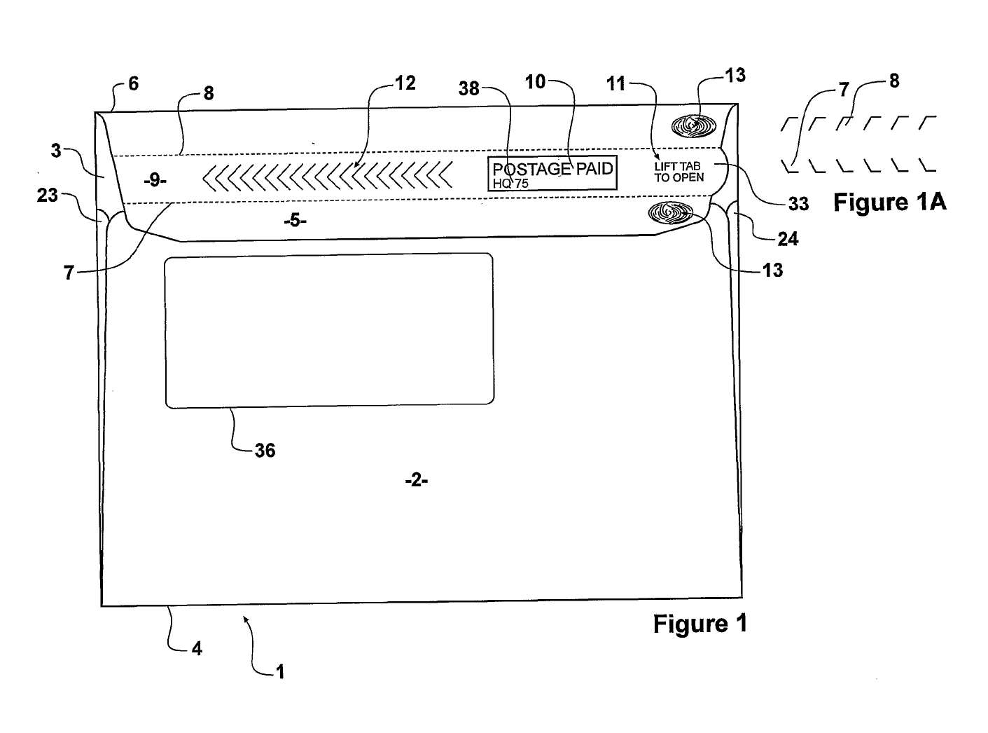

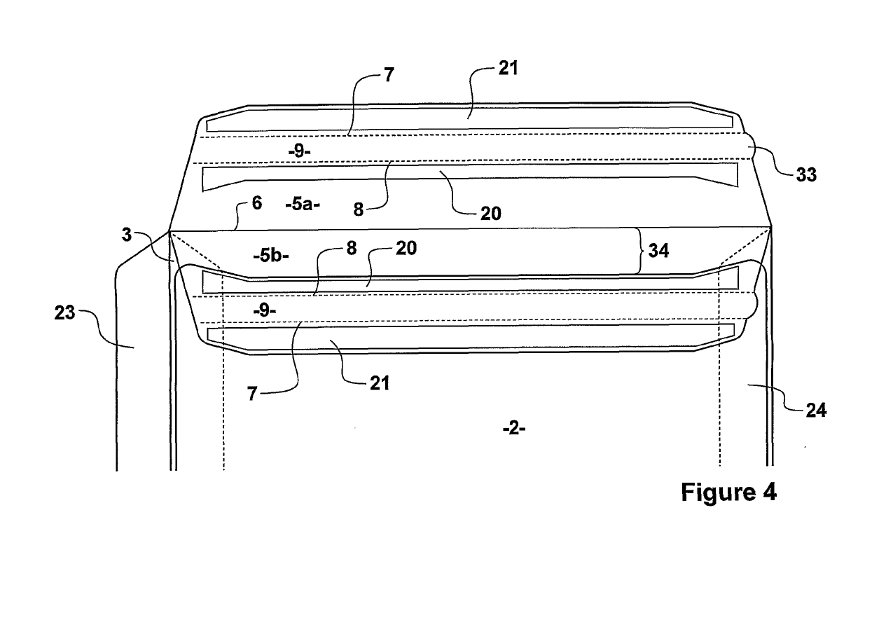

FIG. 1 shows an envelope 1, formed from a blank, which has a front panel 2 connected to side panels 23 and 24. Side panels 23 and 24 are connected to a back panel 3 which is joined to the closure panel or a closure flap 5. The closure flap 5 is connected to the back panel 3 through a fold line 6. In FIG. 4 the flap 5 is shown as 5a and 5b. Flap 5a is the flap 5 shown with envelope 1 in an open position and flap 5b shows the flap 5 in a closed position prior to a first mailing of the envelope.

The closure flap 5 has two lines 7 and 8 of slits, cuts or perforations there across which defines a tear strip 9 there between. The slits, cuts or perforation lines 7 and 8 may be a simple line of perforations or can be alternatives such as those shown in FIG. 1A which have the advantage that a substantially clean tear is made over a wide range of papers from which the envelope 1 may be constructed. The tear strip preferably includes a prepaid postage indicia 10 and may include other material such as opening instructions 11 and 12. Symbols to assist in the opening instructions such as fingerprint symbols 13 may also be provided on closure flap 5 positioned to each side of the tear strip 9.

Each side of tear strip 9 is provided a sealing area such an adhesive area such as glue lines 20 and 21 (FIG. 4). These may be adhesives covered by a removable cover strip (peel and stick) but in the preferred form of the invention are glue lines that become adhesive when wetted. Usually the glue line 21 will be machine wetted and the glue line 20 wetted by tongue or wetted wheel for the second use of the envelope. Accordingly the width of glue line 20 is such that it will hold when tongue wetted.

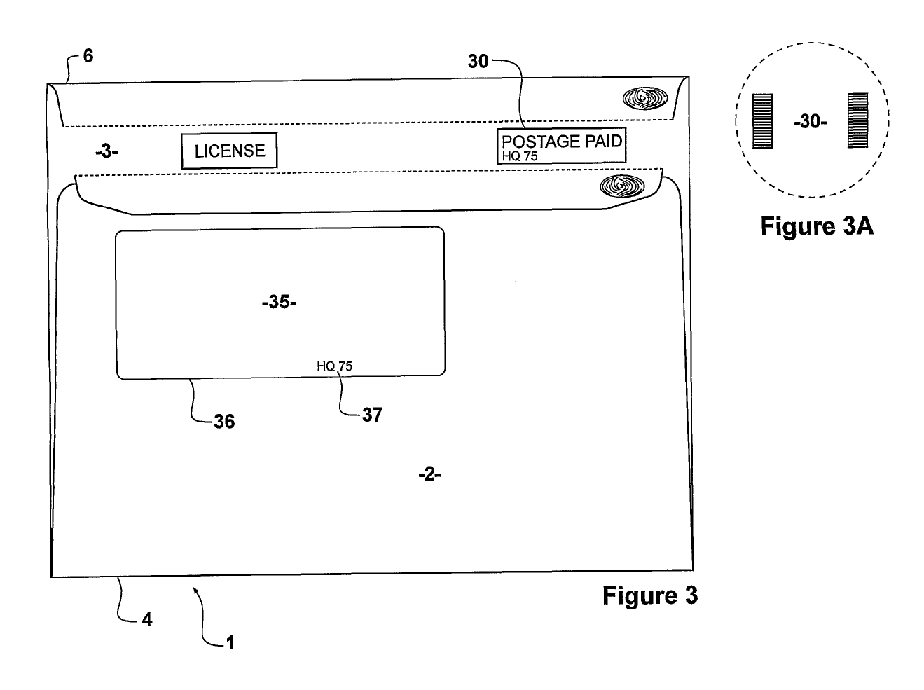

The back panel 3 may also have fold in side panels 23 and 24 and it is desirable that glue line 20 is of sufficient length to overlap the fold in side panels 23 and 24 at each end of the glue line 20 as can be seen in FIG. 4. Desirably glue line 21 is similarly configured. The tear strip 9 is sufficiently wide to reveal a return prepaid post indicia 30 as seen in FIG. 3. Usually this will mean that the minimum width of tear strip 9 will be substantially 20 mm. Considerations of the draw length of some envelope forming machines will usually mean that the maximum width of tear strip 9 will be substantially 18 to substantially 25 mm. To carry a corporate Logo the width must be about 16 to 17 mm wide. This will enable a throat 34 width of between about 3 to 20 mm. In the embodiment of FIG. 4 the throat width is 18.43 mm. Other text (which may include a permit number) such as an indication that the envelope is a business reply mail could also be provided below the tear strip 9. Where the text is a permit number the text cannot be visible during the first mailing.

At either end the tear strip 9 may have an extended end at 33 to aid gripping of the tear strip 9 on the first opening of the envelope 1.

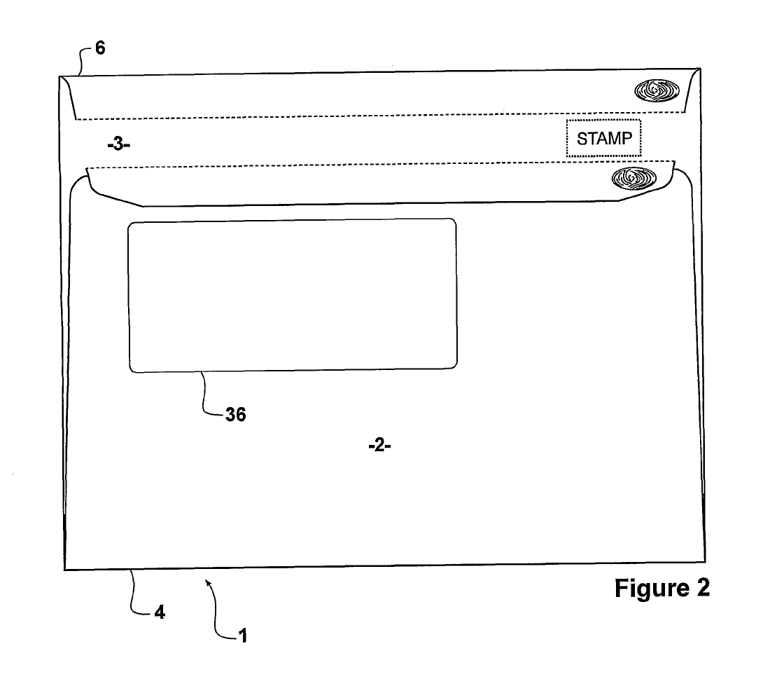

The second pre paid indicia 30 (FIG. 3) is optional and would usually be provided where it is intended that the envelope 1 be used as a return envelope such as in bill paying uses. Where however the envelope 1 is intended as a two use envelope the pre paid indicia 30 would not be provided (FIG. 2).

When the envelope 1 is intended for return use the insert 35 to be returned, part 35 of which can be seen through window 36 in FIG. 3 may carry an identifying indicia 37 which correlates to an identifying indicia 30 on the first use prepaid indicia 10. When the indicia 37 and 38 match or are otherwise correctly associated for the second use the envelope is delivered and charged. If not then the envelope is otherwise dealt with for example by being returned or by seeking payment from the addressee.

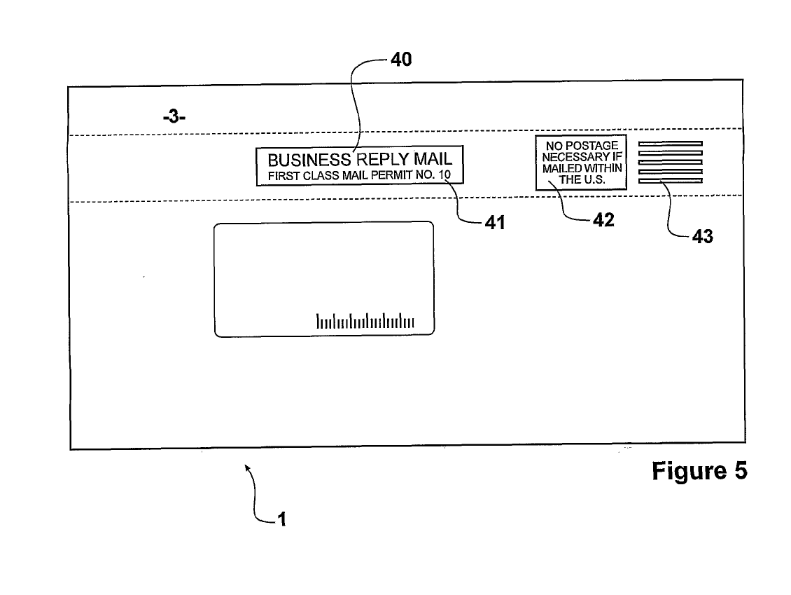

In the construction of FIG. 5 the tear strip once removed reveals a business reply block 40 which carries the permit number 41 used for billing the original sender of the envelope, a “no postage required” indicia 42, and horizontal bars 43.

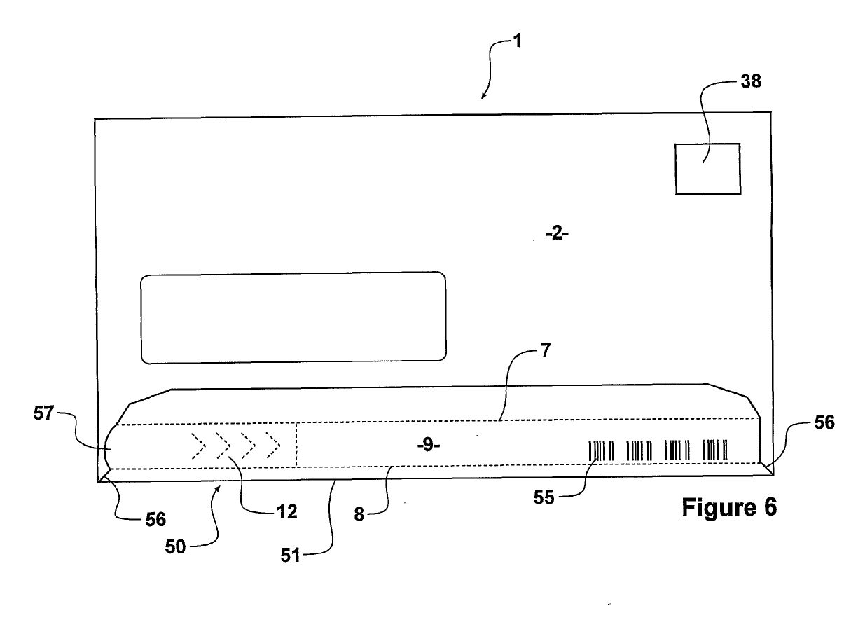

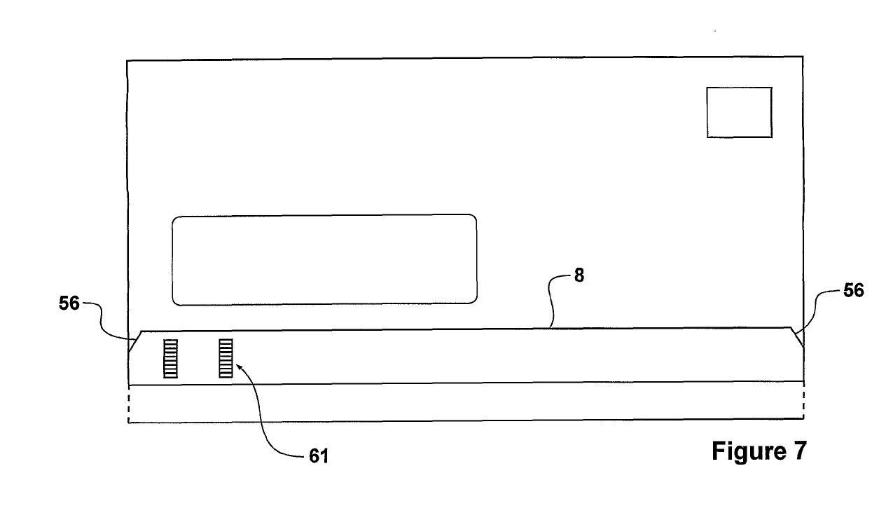

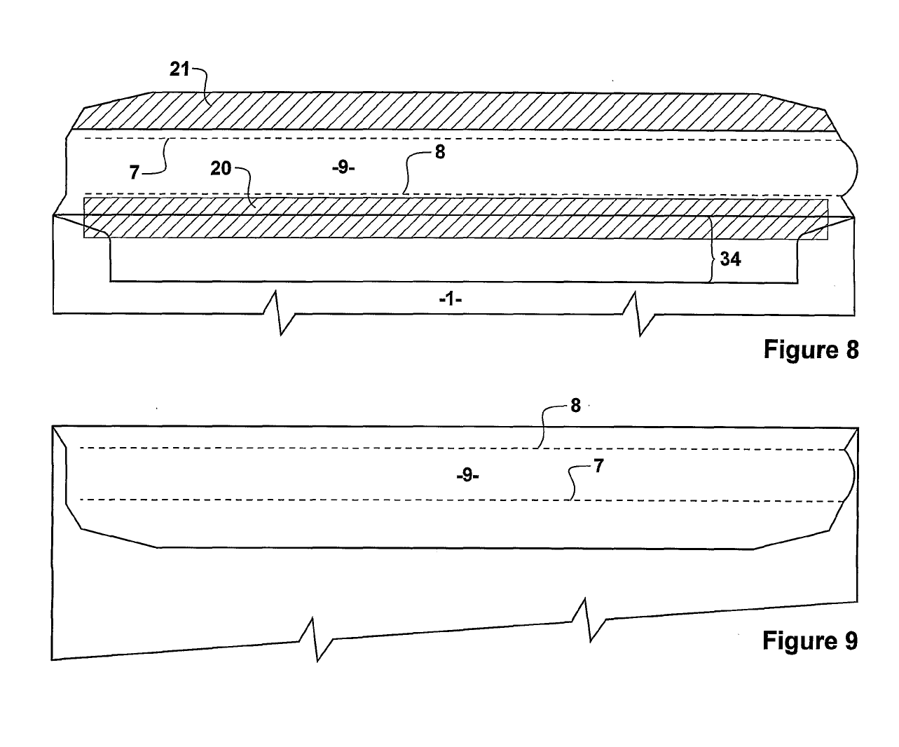

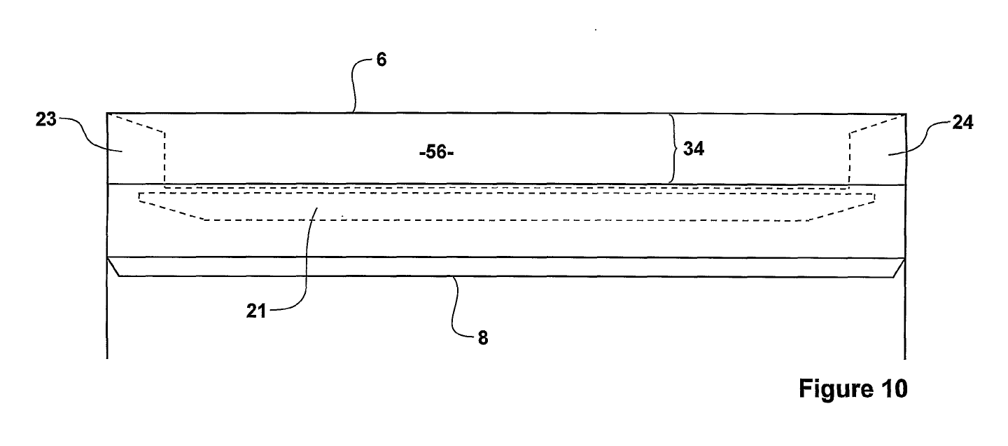

Referring now to FIGS. 6 to 10 the envelope 1 again has a front panel 2. The envelope is intended at least during its first use to be used “upside down” in the sense that the closure panel is at the bottom edge 51 of the envelope 1. The tear lines 7 and 8 are positioned so that during the first use the tear strip 8 is displaced a short distance from the actual bottom edge 51. Thus the tear line 8 does not lie on the bottom edge which reduces the prospect of accidental opening of the envelope during the first use during machine sorting. The tear strip 9 may carry opening information 12 and address information such as barcode 55 which may be fluorescent. A pre paid indicia 61 (FIG. 7) may also be provided on the closure flap 5.

When the tear strip 9 has been removed the remaining part of the closure flap 5 may be resealed using the second glue line 20 allows the envelope 1 to be reclosed. In this embodiment the second use is in an envelope made smaller by folding up the original bottom edge. The reclosed flap will cover the remaining parts of the closure flap left on the envelope by removal of the tear strip 9.

The corners 56 of the second use flap are shaped to avoid catching. This is achieved by pulling in the ends of the flap by about 5 mm. This also protects the tab 57 of the tear strip 9 by displacing the tab 57 inwardly from the edge of the envelope.

In use the envelope 1 has a first use in which the envelope will usually have a pre-printed address or an address showing through aperture 36, and prepaid indicia 10 with a code indicia 38. The envelope 1 is filled, closed by glue line 21 and mailed. The recipient of the envelope 1 removes the tear strip 9 and with it removes the prepaid first mail indicia and any corporate logo on the tear strip 9.

If the recipient is provided with a return prepaid indicia 30 and a return sheet 35 the return sheet 35 and any other material such as a cheque is placed in the envelope 1 with the return address and indicia 37 showing through the window 36. The glue strip 20 is then moistened and stuck to the front panel 2. The envelope can then be re-mailed. For correct posting the the sorting machinery can be set to require that the indicia 37 and indicia 38 are appropriately connected such as by being linked.

If no return prepaid indicia is provided a stamp can be used. Alternatively the prepaid indicia 42 may not be associated with a permit or license number. Elsewhere on the mailpiece when every first mailing envelope is expected to be returned to the sender and all of the response postage is paid by the sender. Alternatively the return postage may be paid by the person sending the return mail or that person may “top up” the postage for the return mailing, i.e. the return postage is part paid by the original sender.

Where the envelope is not intended to be returned to the sender no pre paid return indicia 30 will be provided and the envelope 1 can be re-used by showing an address through the window 36, or writing an address on the rear face of the envelope, and adding a stamp at the appropriate place.

The address and postage payment can be placed on the front panel with the address behind the window and the postage paid by stamp placed on the top right corner of the mailpiece or with use of a response or reply indicia revealed in the space on the front panel behind the removable strip, which is removed when the envelope is opened.

As a further option the address can be written on the back panel with a stamp placed on the corresponding top right corner. The first mailing front face is then the second or response or reply mailing back face. The window has been blanked with paper and the 1st mailing postage indicia or stamp has been removed by removing the zipper.

One intended use embodies use of a Postal Providers response or reply mailing service. This service is commonly provided by postal providers such as the USPS or Royal Mail to business customers with high mailing volumes who seek a prompt response with a cheque payment or credit card application. The first mailing sender agrees to pay the postage to encourage a quick response from the recipient. The mailpieces are usually inserted by machinery into envelopes carefully designed to ensure they are capable of being inserted at high speeds without fault and where the range of inserting machinery used is quite varied in their mechanical operations.

The closure panel requires carefully shaping and dimensioning to ensure the overall outline is streamlined to be opened and closed and sealed by the inserting machinery at very high speeds.

Embodied within the flap is the method of opening in the form of a zipper or removable strip. The flap cannot be damage as it is also the method of closure for the 2nd use of the envelope. The dimensions and location of the zipper are carefully calculated to ensure upon first closure and sealing the 1st gum line is below the throat of the envelope sufficient that upon opening the mailpiece by pulling the zipper the second gum line is also clear of the throat thus providing adequate closure of the mailpiece second use.

Postal providers normally have fairly narrow parameters for placement of the postage payment stamp printed postage impression or response indicia. The top right corner of the address face of the envelope is typically used. The stamp or indicia for this invention are positioned to sit within the regulations required clear space but also, on the removable strip directly or behind the removable strip so that upon removal of the strip, the response indicia is revealed in full.

If the preferred format for the first mailing is to print a PPI [printed posted impression] top right corner of the front panel the reply or response use of the mailpiece will require a stamp known as stamped mail or a printed response services indicia. Neither this stamp or response services indicia may be visible when the envelope is used for the 1st mailing.

When the second mailing mode uses a response service this service may also require a permit or license number to be visible on the address face of the mailpiece. In using the response service, the sender will not expect every recipient to make use of the response service. The intention of the postal service provider is to only charge the sender postage for the mailpiece items send back.

In the response or second use the postal sorting equipment will firstly recognize the response indicia which then checks for the required license or permit number. This permit or license number may also be checked with the response address. If there is a mismatch the mail piece is not delivered. This prevents fraudulent use of the license.

The license or permit details are carried in the address block. Alternatively the license detail may be carried somewhere else on the front panel. FIG. 3 the license and its number will show in the window associated with the response address. In FIG. 5 the license and its number are carried in a separate panel above the address, concealed by the zipper on the first mailing journey.

Typically the response indicia includes and carries in association, heavy dark printed lines or bars. These lines which are of a definite weight and size assist the postal service provider to recognize the mailpiece as a response service item. These lines are also able to be concealed beneath the zipper to conceal them from sorting equipment for the 1st mailing (FIGS. 3A and 5).

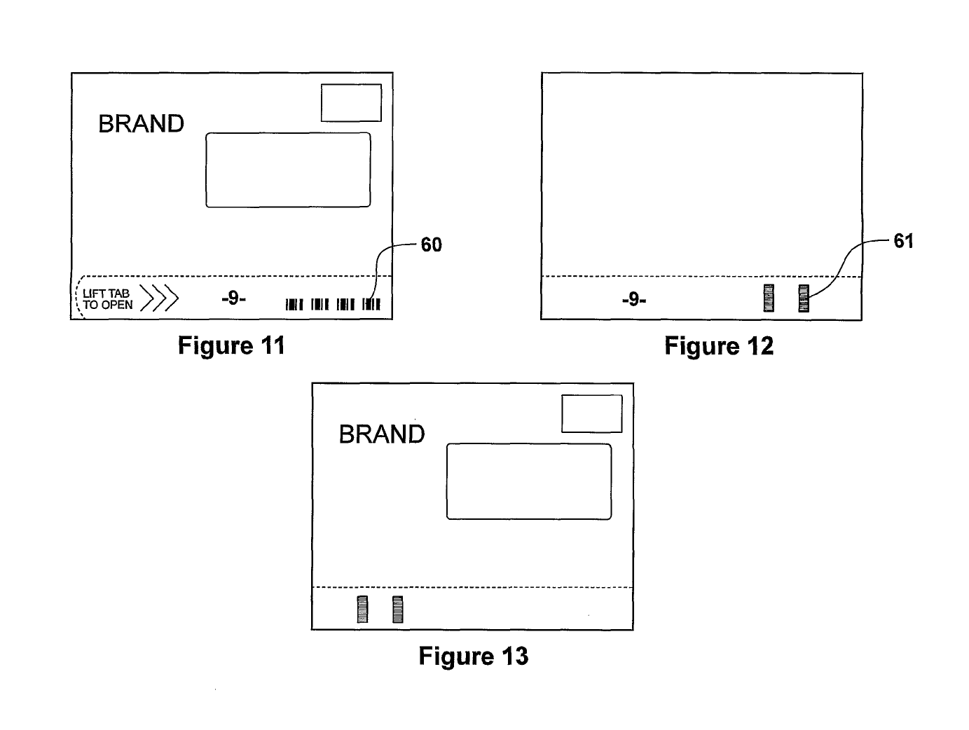

FIGS. 11, 12 and 13 show an envelope in a format suitable for use in such countries as the Germany. Its purpose is to remove the Route Tag 60 placed bottom right, first mailing. The tear strip 9 along the bottom when removed removes the Route tag 60. The back panel folds over and carries the RS FIM 61.

When reposted the window is reused. So the removal of the tear strip 9 enables postal service compliance.

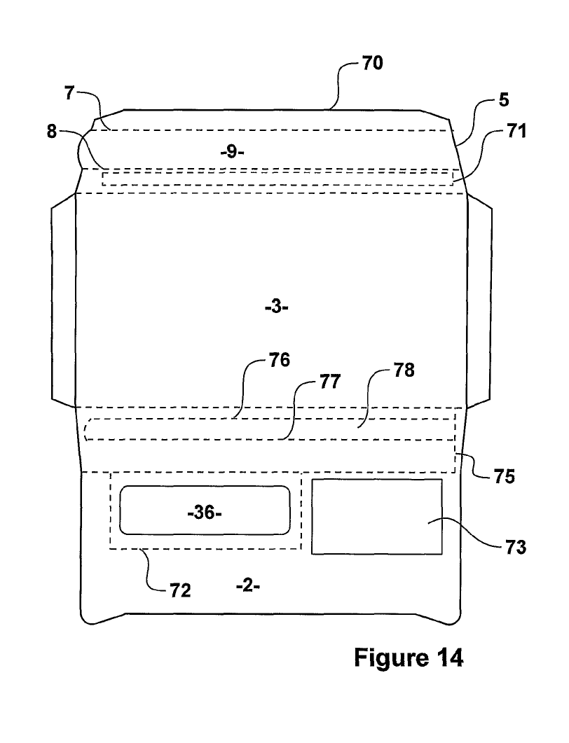

Referring now to FIG. 14 a blank is again shown which is similar to the construction of FIG. 6. A front panel 2 is connected to a back panel 3. Closure flap 5 carries tear lines 7 and 8 with a tear strip 9 therebetween. If desired the tear strip 8 is positioned a short distance from the position of fold line forming the bottom edge 51 of the closed envelope. Glue lines are provided between tear strip 9 and the edge 70 of the envelope and between tear strip 9 and edge 51 as for FIG. 6. The glue line between the tear strip 9 and edge 51 may be tongue wettable or may be covered by a peelable strip indicated at 71.

The window 36 is covered by a transparent patch 72 and a peelable patch 73 may be provided.

A paper patch 75 is provided with tear lines at 76 and 77 defining a second tear strip 78 the paper patch 75 is adhered to the envelope, for example by gluing, except that the patch is not glued to the blank below the tear strip 78. Thus tear strip 78 can be removed.

The envelope of this figure is described in a compendious way and it may be that only one of the features comprising the peelable patch and the tear strip 78 will be provided.

Tear strip 9 may have first use branding and postal indicia thereon which is removed when the envelope is opened. Return address information may be provided herebelow as previously described herein. The tear strip 78 may also or alternatively have first use address information thereon which is removed when the strip 78 is removed. Again return address information may be provided therebelow.

Peelable patch 73 may also have first use address information thereon which can be removed and again return address information can be provided behind the patch 73. As a further alternative return address information can be shown through the window 36. In the preferred embodiment of this invention the envelope can be opened by removing tear strip 9 and resealed by the use of the glue line between the line 8 and fold 51. Removal of the tear strip 78 will remove first use address information including postal bar-coding and the return address can be positioned therebelow or show through window 36. This construction is suited to blank fed envelope making apparatus.

### ADVANTAGES

a) The envelope of the invention has the advantage that the envelope can be used twice either for a return mailing or as a second use without significant structural changes.
b) The two use aspect can lead to a reduction in paper usage and waste. In a postal market all of the first mailing envelopes are put to waste.
c) The envelope offers a simple effective envelope format providing easy re-use where markings relevant to the first mailing which may include corporate branding are removed by the first opening sufficient to offer a clean envelope that can be re-sealed, and can accommodate a suitable method of postage payment, whether a stamp or response service indicia, for re-posting.

### Variations

Throughout the description of this specification, the word “comprise” and variations of that word such as “comprising” and “comprises”, are not intended to exclude other additives, components, integers or steps.

It will of course be realised that while the foregoing has been given by way of illustrative example of this invention; all such and other modifications and variations thereto as would be apparent to persons skilled in the art are deemed to fall within the broad scope and ambit of this invention as is hereinbefore described.

1. A blank for an envelope including a front panel, a rear panel and a closure panel, the closure panel being connectable in use to the front panel, the blank having two sealing areas by which the closure panel may be connected to the front panel in use, a removable strip between the sealing areas, the removable strip being of sufficient dimensions to receive indicia associated with a—first mailing thereon, at least some of which indicia are removed when the envelope is opened by removing the removable strip after the first mailing.

2. A blank as claimed in claim 1 wherein a second mailing prepaid indicia is provided on the front panel which becomes at least substantially visible in use when the removable strip is removed.

3. A blank as claimed in claim 1 wherein a stamp can be placed on the front panel which becomes at least substantially visible in use when the removable strip is removed.

4. A blank as claimed in claim 1 wherein a—second—mailing part payment indicia is provided on the front panel which becomes at least substantially visible in use when the removable strip is removed.

5. A blank as claimed in claim 1 wherein a permit indicia may be provided on the front panel which becomes at least substantially visible in use when the removable strip is removed.

6. A blank as claimed in claim 1 wherein the removable strip is at least substantially 10 mm in width.

7. A blank as claimed in claim 4 wherein the removable strip is between substantially 10 mm and substantially 25 mm in width.

8. A blank as claimed in claim 1 wherein a second prepaid indicia is provided on the front panel and the second prepaid indicia is associated with a selected indicia, permit or license.

9. A blank as claimed in claim 7 wherein the selected indicia is a number.

10. A blank as claimed in claim 1 wherein a response sheet is—provided. with the first mailing, the response sheet carrying an indicia associable with the selected indicia associated with the second prepaid indicia.

11. A blank as claimed in claim 10 wherein the indicia on the response sheet is a number- and/or a bar-code.

12. A blank as claimed in claim 10 wherein the blank includes a window, and the response sheet is dimensioned so that in use during the second mailing the selected indicia on the response sheet is visible through the window.

13. A blank as claimed in claim 12 wherein the selected indicia and the indicia on the response sheet are substantially the same or are associated one with the other.

14. An envelope formed, from a blank according to claim 1.

15. A method of billing a postal transaction including the steps of providing an envelope according to the preceding paragraph, which envelope has a window, a response sheet carrying an indicia, a prepaid indicia, and a selected indicia associated with the prepaid indicia, passing the envelope through a mail scanning device during the second mailing of the envelope, checking that the indicia on the response sheet is correctly associated with the selected indicia and/or the prepaid indicia.

16. A method as claimed in claim 15 wherein said method further includes the step of billing the entity providing the response sheet or some other entity if the response indicia on the response envelope is correctly associated with the indicia on the response sheet.

17. A method as claimed in claim 16 wherein the correct association occurs when the numbers are substantially the same or the response indicia on the envelope matches a barcode which is associated with the selected indicia.

18. A blank for an envelope including a front panel, a rear panel and a closure panel, the closure panel being connectable in use to the front panel, the blank having two sealing areas by which the closure panel may be connected to the front panel in use, a removable strip between the sealing areas, and a further removable strip or panel in or on the blank and independent of the removable strip.
